(19) United States
(12) Patent Application Publication
(10) Pub. No.: US 2023/0114230 A1
(43) Pub. Date: Apr. 13, 2023

(54) FURNACE ROLLER, ROLLER HEARTH FURNACE, USE OF THE FURNACE ROLLER AND PROCESS FOR PRODUCTION OF A HOT-FORMED AND AT LEAST PARTLY PRESS-HARDENED VEHICLE COMPONENT

(71) Applicant: BENTELER MASCHINENBAU GMBH, Bielefeld (DE)

(72) Inventors: Radovan KOUT, Liberec (CZ); Petr NEMEC, Rumburg (CZ); Borek DVORAK, Jablonec nad Nisou (CZ); Daniel SIDA, Semily (CZ)

(21) Appl. No.: 17/961,725

(22) Filed: Oct. 7, 2022

(30) Foreign Application Priority Data
Oct. 8, 2021 (EP) 21201728.9

(51) Int. Cl. F27B 9/24

(52) U.S. Cl. CPC F27B 9/2407; F27M 2001/02; F27M 2001/1565

(57) ABSTRACT

A furnace roller for a roller hearth furnace has a hollow cylindrical ceramic roller body having an outer oxidic coating. The roller body has outer longitudinal fins and longitudinal grooves that run in linear longitudinal direction of the roller body. The configuration reduces the contact area between the roller body and the blanks to be transported. The furnace rollers are suitable for use in roller furnaces in hot forming lines for the press hardening of AlSi-coated steel blanks.

### RELATED APPLICATIONS

The present application claims priority of European Application Number 21 201 728.9 filed Oct. 8, 2021, the disclosure of which is hereby incorporated by reference herein in its entirety.

### FIELD

The present disclosure relates to a furnace roller for a roller hearth furnace having such a furnace roller, and to the use of a furnace roller in a roller hearth furnace of a hot forming line for press hardening, and to a process for producing a hot-formed and at least partly press-hardened vehicle component.

### BACKGROUND

In the continuous heat treatment of sheet metal, continuous furnaces are used in sequential production processes. In press hardening processes, the roller hearth furnace is the predominant heat treatment plant type in use nowadays. A roller hearth furnace is suitable both for the indirect and for the direct press hardening process, and for high process reliability and plant availability. As well as the furnace space and heating technique, a component of the roller hearth furnace is what is called the roller conveyor, or the roller track. Depending on the furnace length and roller diameter and distance, a multitude of rotatable furnace rollers form a continuous transport track.

Furnace rollers are available in ceramic or metallic versions. Furnace rollers are made of steel, silicon carbide (SiC), quartz or mullite. In addition, plasma-coated steel rollers are used. A steel roller is coated here with ceramic, for example aluminum oxide or zinc oxide. Furnace rollers also have roller bodies provided with an oxidic bearing surface coating.

Such a roller is described in DE 10 2011 051 270 A1.

DE 10 2017 114 165 A1 describes a furnace roller for a roller hearth furnace. The roller body has a coating on the surface comprising a ceramic material from the group of mullite, alumina, SiC or else mixtures thereof.

EP 2 703 759 A1 describes furnace rollers that are to be used in heat treatment plants for aluminum-silicon-coated (AlSi-coated) steel sheets. The furnace rollers have a core having a coating on the outer surface. The core comprises a metallic or ceramic material.

DE 10 2016 124 649 A1 describes a furnace roller having a corrugated outer surface, wherein the corrugated outer surface has a multitude of wave crests and wave troughs over the longitudinal extent of the furnace roller. The purpose of this outer surface is reduced wear on cross-centering or cross-transportation of heated metal parts, or those that are to be heated, directly within the plane of the roller track.

The press hardening of manganese-boron-alloy steels to give high-strength bodywork components is established in automobile manufacture. Such high-strength bodywork components improve occupant safety and reduce component weight and hence the total weight of a vehicle. In press hardening, also called hot forming, a steel sheet made of a manganese-boron steel is heated to a temperature above the specific austenitization temperature of the material. This is effected in a roller hearth furnace. Immediately thereafter, the heated steel sheet is inserted into a press mold and hot-formed to give the shaped component, and cools down during shaping. The shaped components are hardened by the cooling while clamped in the press mold. Such shaped components have high strength values, for example, shaped components made from manganese-boron steel sheets able to achieve strengths exceeding 1000 MPa, or in the range from 1300 MPa to 2000 MPa, by hot forming or press hardening. Steel sheets having a metallic AlSi coating are used in press hardening. Such a metallic AlSi coating protects the steel sheets from scaling. Since the AlSi coating melts at temperatures of about 600° C., however, the coating is transferred to the surface of the furnace rollers by the constant contact. This results in process-disrupting caked material. In addition, there is infiltration of the melt into the microstructure of the furnace rollers, which is able to have an adverse effect on the service life of the furnace rollers. The caked material on the furnace roller is able to lead to inhomogeneous heating, austenitization or formation of alloys by the AlSi precoating, and to impermissibly fluctuating component properties.

### SUMMARY

The present disclosure provides a furnace roller that has been improved for operational use, such as in roller furnaces of hot forming lines for the press hardening of coated steel sheets, having a longer service life, and of increasing the overall plant effectiveness of a roller hearth furnace and a hot forming line having such a roller hearth furnace.

The disadvantageous component properties mentioned also give rise to the object of improving a process for press hardening of motor vehicle components.

A furnace roller for a roller hearth furnace has a hollow cylindrical roller body made of a ceramic material. The roller body has been provided with an outer coating. The coating is an oxidic bearing surface coating.

According to at least one embodiment of the present disclosure, the roller body has outer longitudinal fins and, between the latter, longitudinal grooves that run in linear longitudinal direction of the roller body.

In spite of the reduced bearing area and the result that contact is more linear with soft or molten AlSi precoating within the first sections of the roller hearth furnace, there is no critical dipping of the longitudinal fins into the coating, and adhesion between longitudinal fins and steel sheet is reduced, such as when the furnace roller is used in the press hardening method, and therefore in heating and alloy formation in the roller hearth furnace at furnace temperatures between 800 and 980° C. This is because, even if the steel sheet temperature follows the furnace temperature with a time delay, the melting temperature of the AlSi precoating will be rapidly exceeded and only gradually increased to a degree as a result of progressive diffusion of Al and Si into the alloy of the steel sheet, which rules out adhering material further.

In at least one embodiment of the present disclosure, the furnace roller has longitudinal fins, such as when used in a hot forming line for press hardening of coated steel sheets, and caked material does not adhere and simply falls off in operation. A self-cleaning effect occurs.

The longitudinal fins and longitudinal grooves extend in a linear manner over the entire length of the roller body. In addition, the longitudinal fins and longitudinal grooves are also able to extend only over part of the length of the roller body. The longitudinal fins here are interrupted. Interrupted longitudinal fins, however, are interrupted only slightly, i.e. over a small proportion of the length; such as, a sum total of the lengths of all interruptions is not longer than thirty percent of the length of the furnace roller.

The longitudinal fins have an end face rounded at the outer circumference in cross section, and the longitudinal grooves a rounded groove base.

The end face has a radius, and each groove base has a radius, where the radius of the end face is greater than the radius in the groove base.

In at least one embodiment of the present disclosure, the longitudinal fins of a furnace roller have a fin height and the roller body has a wall thickness measured between the groove base and the inner circumference of its interior, where the ratio of the fin height to the wall thickness of the roller body is between 1:1 and 1:2. The fin height is measured radially between the fin root or groove base and the outer end face of a fin.

In at least one embodiment of the present disclosure, the roller body has a middle length section and terminal end sections, where the middle length section has an external diameter greater than the external diameter of the end sections.

The furnace roller with its terminal end sections is in each case guided through an outer side wall of a roller hearth furnace. A roller hearth furnace of the according to at least one embodiment of the present disclosure has a furnace chamber and side walls that bound the surface chamber, and a furnace roller. The roller hearth furnace has a roller track formed from a multitude of furnace rollers of the invention.

In at least one embodiment of the present disclosure, a roller has a ceramic roller body comprising oxide ceramic or carbide ceramic or nitride ceramic. The ceramic materials from which the roller body is produced are in mullite ceramics from the Al2O3-SiO2 class or fused silica, i.e. refractory silica materials or silicon-carbon (SiC). In at least one embodiment of the present disclosure, a ceramic material for the roller body is mullite.

The roller body is an extrudate, i.e. has been produced by extrusion. In the case of production by extrusion, the roller body receives its geometric configuration with longitudinal fins and longitudinal grooves. The outer surfaces require only minor reprocessing, such as of the grinding type. Reworking by grinding is able to be effected in the end sections, i.e. the terminal longitudinal sections of the roller body.

The outer surface of the roller body, such as the bearing surfaces, is provided with a coating. The coating is an oxidic coating. The oxide-based coating reduces the wettability of the rollers with respect to metal melts, i.e., a coating material such as an aluminum-silicon alloy. The bearing surface coating of the furnace roller functions as a dense protective layer for the ceramic roller body. The outer surface or circumferential face of the roller body is sealed by virtue of the coating, and hence is smooth and of low porosity. Surface unevenness and porosity in the roller body are filled and compensated for by the coating.

The coating of the roller body includes an oxide selected from the group of aluminum oxide (Al₂O₃), zirconium(IV) oxide (ZrO₂), chromium(III) oxide (Cr₂O₃), yttrium oxide (Y₂O₃), silicon dioxide (SiO₂), calcium oxide (CaO), magnesium oxide (MgO), potassium oxide (K₂O), titanium(IV) oxide (TiO₂) and/or iron(II) oxide (FeO), in a proportion of at least 50% by weight (percent by weight). In addition, the coating is able to contain boron nitride (BN) or boron nitride (BN).

In at least one embodiment of the present disclosure, the outer ceramic coating of the roller body extends over the middle length section of the roller body. The middle length section forms the working width of the furnace roller. The end sections of the roller body are uncoated.

In at least one embodiment of the present disclosure, the combination of a reduced bearing area at which the furnace roller comes into contact with a metal sheet to be transported, and the chemical barrier between furnace roller and the aluminum-silicon coating of the blanks to be transported. The chemical barrier results from the synergistic interaction of the composition of the roller body and the coating.

Minimization or reduction of the effective bearing area of the furnace rollers at the outer circumference is achieved by the shaping with the longitudinal fins and the longitudinal grooves in between.

The outer coating of the roller body is able to be executed as a thermally sprayed layer. The coating is also able to be formed from a suspension that has been applied to the roller body and then consolidated, or baked.

The present disclosure provides for the use of a furnace roller in a roller hearth furnace in a hot forming line for hot forming and press hardening of steel sheets, such as of AlSi-coated sheet metal.

The furnace roller has a hollow cylindrical roller body with an interior closed at either end by an internal plug made of geopolymer, in a terminal longitudinal section directed toward the end of the roller. The interior of the roller body is bounded to the left and right by a plug, where the plug is disposed at a distance from each end face of the roller body. This enables insulation of the furnace rollers in the region of the transition between the furnace chamber and the outside environment bounded by the side wall of the furnace. The plugs insulate and seal the interior of the roller body, with the plugs being gas-permeable. On account of the gas permeability of the plugs, the pressure is able to be equalized. The geopolymer of which the plugs comprises an alkali-activated aluminosilicate.

The geopolymer plugs provided in the region of the terminal longitudinal sections result in internal insulation in the region of the transition between the furnace chamber and the outside environment separated by the side wall of the furnace. This reduces the transfer or removal of heat from the interior of the furnace, such as from the interior of the furnace roller. The furnace roller has improved insulation properties and distinctly increased thermal cycling stability, and is able to efficiently compensate for process-related changes in temperature. Roller fractures are able to be reduced. As a result, the service lives of the furnace rollers and hence plant availability are improved, and operating costs are reduced. Heat losses are reduced, and the energy intensity of furnace operation is reduced. The plugs in the terminal longitudinal sections of the roller body contribute to an improvement in operation of the furnace roller, such as with regard to thermal and mechanical durability. The duration of utilization of the furnace rollers is increased further. In addition, plant effectiveness is improved, since the plugs that bound the interior, in the terminal longitudinal sections of the roller body, thermally insulate and shield and hence protect the region of the mounting of the furnace rollers.

In at least one embodiment of the present disclosure, a geopolymer comprises an aluminosilicate activated by alkali, SiO2 and Al2O3 with a production-related residue.

The present disclosure relates to a process for producing a hot-formed and at least partly press-hardened vehicle component, having the following steps:
providing an Al-Si-precoated steel sheet made of a temperable steel alloy,
heating the steel sheet and forming an alloy of the AlSi precoating with the steel alloy in a roller hearth furnace,
wherein, in the heating and alloy formation, at least a furnace roller of the present disclosure and/or a roller hearth furnace configured in accordance with the present disclosure is used,
wherein the heating and alloy formation are effected at a furnace temperature between 800° C. and 980° C.,
transferring the heated steel sheet to an at least partly cooled press mold and
hot forming and press hardening the steel sheet in the press mold to give the vehicle component.

Depending on the actual austenitization temperature of the steel alloy used, the furnace temperature is set within the aforementioned interval, and hence the temperature of the steel sheet as well.

The heating of and alloy formation by the steel sheet provided with an aluminum-silicon coating is effected in a roller hearth furnace configured in accordance with the present disclosure, equipped with furnace rollers of the present disclosure at least in the first furnace zones that are intended for austenitization of and alloy formation by the steel sheet.

In at least one embodiment of the present disclosure, there are no shifts, vibrations or rotations or imbalances as a result of caked material in the transportation of sheet steel through the roller hearth furnace. Thus, the configuration of the present disclosure allows for positional accuracy in the acceptance and transfer of the heated steel sheets to the press mold.

In at least one embodiment of the present disclosure, there is intermediate cooling and/or further heating for creation of a steel sheet heated to different temperatures in different regions, such that an only partly hardened motor vehicle component is produced.

The process of the present disclosure enables the production of high-strength motor vehicle components having a high-quality coating.

### BRIEF DESCRIPTION OF THE DRAWINGS

The present disclosure is additionally described hereinafter with reference to drawings. The figures show:

FIG. 1 a perspective view of a furnace roller according to the present disclosure;

FIG. 2 the furnace roller in a side view according to the present disclosure; and

FIG. 3 an end view of the furnace roller according to the present disclosure.

### DETAILED DESCRIPTION

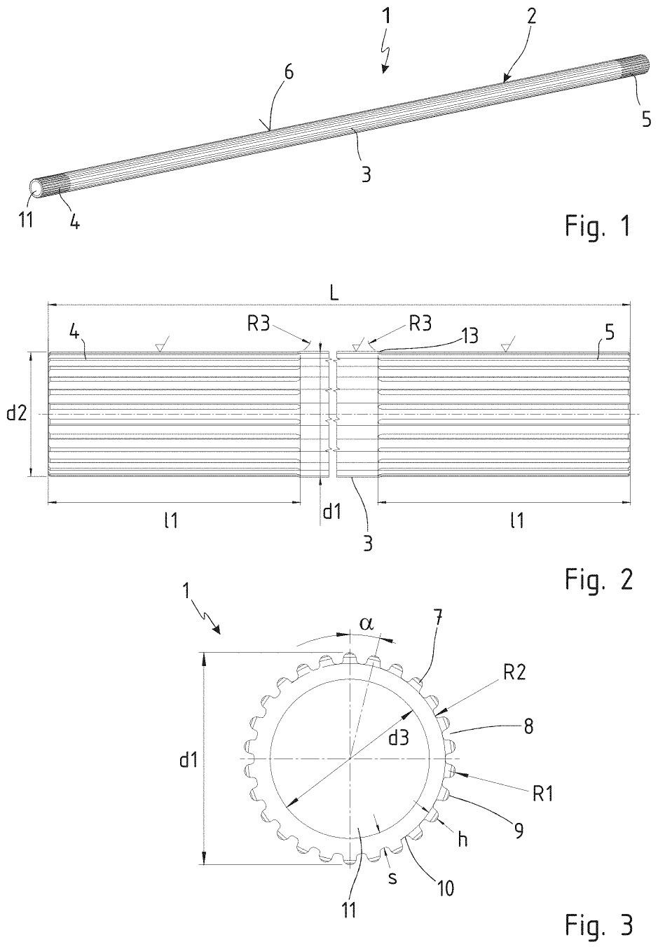

With reference to FIG. 1, FIG. 2 and FIG. 3, an furnace roller 1 for a roller hearth furnace is elucidated.

The furnace roller 1 has a hollow cylindrical roller body 2 made of a ceramic material. The roller body 2 comprises of mullite. The roller body 2 has a middle length section 3 and an end section 4, 5 at either end. The middle length section 3 of the roller body 2 has been provided with an outer coating 6. The coating 6 comprises an oxidic material. The coating 6 comprises a mixture of zirconium oxide, aluminum oxide, boron nitride and/or silicate. The outer coating 6 has been applied in the middle length section 3.

The coating 6 is executed as a thermally sprayed layer. The coating 6 is also able to be formed by an applied and baked suspension.

The roller body 2 has outer longitudinal fins 7 and longitudinal grooves 8 that run in linear longitudinal direction of the roller body 2. In the working example shown, the longitudinal fins 7 and the longitudinal grooves 8 formed in between extend in a linear manner over the entire length L of the roller body 2. The longitudinal fins 7 are also able to be interrupted over the course of the length L of the roller body 2.

The longitudinal fins 7 and the longitudinal grooves 8 that run in between are distributed homogeneously over a circle sector on the outer circumference of the roller body 2. The longitudinal fins 7 are arranged over the circumference of the roller body 2 in a circle sector, each offset at an angle α.

The longitudinal fins 7 have a rounded outer end face 9. The longitudinal grooves 8 have a rounded groove base 10. The end face 9 of a longitudinal fin 7 has a radius R1. The groove base 10 of a longitudinal groove 8 has a radius R2. The radius R1 of the end face 9 is greater than the radius R2 in the groove base 10.

The roller body 2 is hollow cylindrical and has an interior 11. Within each of the end sections 4, 5 is disposed a plug made of a geopolymer, which is not shown in the drawings.

The roller body 2 comprises of a ceramic material and is an extrudate. The end sections 4, 5 have been worked by grinding at the outer circumference. The middle length section 3 has an external diameter d1. In the end sections 4, 5, the roller body 2 has an external diameter d2. The end sections 4, 5 have been worked by grinding and are reduced in diameter, such that the external diameter d1 in the middle length section 3 is greater than the external diameter d2 in the end sections 4, 5. The end sections 4, 5 have a length l1 shorter than the total length L of the roller body 2. The middle length section 3 is several times longer than an end section 4, 5. The middle length section 3 has a transition to a terminal end section 4, 5, in each case via a rounded transition 12 having a radius R3.

The longitudinal fins 7 have a fin height h. The fin height h is measured from the groove base 10 up to the outer point on an end face 9. In addition, the roller body 2 has a wall thickness s measured between the groove base 10 and the inner circumference d3 of its interior 11. The ratio of the fin height h to the wall thickness s of the roller body 2 is between 1:1 and 1:2, or between 1:1.25 and 1:1.75.

The outer bearing surface of the furnace roller 1 is reduced by virtue of the configuration of the longitudinal fins 7 with the longitudinal grooves 8 in between. As a result, the contact area between the furnace roller 1 and a metal sheet to be transported is reduced. In addition, a chemical barrier is formed between the furnace roller 1 and the sheet to be transported, which is implemented by the outer coating 6 of the roller body 2.

In at least one embodiment of the present disclosure, furnace rollers 1 are employed in roller furnaces. The furnace rollers 1 are suitable for roller furnaces in hot forming lines for press hardening of coated steel sheets, such as for press hardening of aluminum-silicon-coated (AlSi-coated) steel sheets.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

1-11. (canceled)

12. A furnace roller, the furnace roller comprising:
a roller body, wherein the roller body has an outer coating, the roller body has outer longitudinal fins and longitudinal grooves both extending linearly in a longitudinal direction of the roller body, and the roller body has a hollow cylinder shape.

13. The furnace roller according to claim 12, where the roller body comprises a ceramic material.

14. The furnace roller according to claim 12, wherein each of the longitudinal fins has a rounded end face, and each of the longitudinal grooves has a rounded groove base.

15. The furnace roller according to claim 14, wherein the rounded end face has a first radius and the rounded groove base has a second radius , and the first radius is greater than the second radius.

16. The furnace roller according to claim 14, wherein each of the longitudinal fins has a fin height, the roller body has a wall thickness measured between the rounded groove base and an inner circumference of an interior of the roller body, and a ratio of the fin height to the wall thickness of the roller body is between 1:1 and 1:2.

17. The furnace roller according to claim 12, wherein the roller body has a middle length section and terminal end sections, the middle length section has an external diameter greater than an external diameter of the terminal end sections.

18. The furnace roller according to claim 12, wherein the roller body comprises an extrudate.

19. The furnace roller according to claim 12, wherein the outer coating comprises at least one oxide selected from the group consisting of aluminum oxide (Al₂O₃), zirconium(IV) oxide (ZrO₂), chromium(III) oxide (Cr₂O₃), yttrium oxide (Y₂O₃), silicon dioxide (SiO₂), calcium oxide (CaO), magnesium oxide (MgO), potassium oxide (K₂O), titanium(IV) oxide (TiO₂), iron(II) oxide (FeO), or boron nitride (BN).

20. The furnace roller according to claim 12, wherein the roller body comprises an interior and terminal end sections, and in each terminal end section of the terminal end sections comprises a geopolymer plug.

21. A method of making a hot-formed and press-hardened vehicle component, the method comprising:
using an Al-Si-precoated steel sheet comprising a temperable steel alloy;
heating the Al-Si-precoated steel sheet;
forming an alloy of the Al-Si precoated steel sheet in a roller hearth furnace;
transferring the heated Al-Si-precoated steel sheet to an at least partly cooled press mold; and
hot forming and press hardening the Al-Si-precoated steel sheet in the press mold,
wherein, in the heating and the forming of the alloy, at least a furnace roller according to claim 12 is used, and
the heating and the forming of the alloy are at a furnace temperature between 800° C. and 980° C.
